(19) United States
(12) Patent Application Publication
(10) Pub. No.: US 2007/0046693 A1
(43) Pub. Date: Mar. 1, 2007

(54) Process model engine and method for constructing process models and managing their synchronized representations

(76) Inventors: Keith Manson, Albany, CA (US); Ozan Serim, San Francisco, CA (US)

Correspondence Address: REED SMITH, LLP, TWO EMBARCADERO CENTER, SUITE 2000, SAN FRANCISCO, CA, 94111, US

(21) Appl. No.: 11/230,888

(22) Filed: Sep. 19, 2005

Related U.S. Application Data
(60) Provisional application No. 60/711,284, filed on Aug. 24, 2005.

(51) Int. Cl. G09G 5/00

(52) U.S. Cl. 345/619

(57) ABSTRACT

The primary component of the present invention is an automated method for transforming any suitably well-formed textual description of a process into a series of diagrammatic representations of that process. The secondary component of this invention is an automated method for transforming any of these diagrammatic representations into a corresponding textual description. These complementary methods are specific implementations of a more fundamental process modeling method for constructing a fundamental object structure from which a coordinated set of diverse representations may be uniformly generated, and hence, automatically synchronized. This fundamental process modeling method derives directly from the underlying mechanisms of syntactic and semantic representation provided by metaScript, a software technology presented in a previous patent application (Ser. No. 09/883,693: “Computer System With Natural Language To Machine Language Translator”).

### CROSS REFERENCE TO RELATED APPLICATIONS AND CLAIM OF PRIORITY

This invention claims priority to the following co-pending U.S. provisional patent applications, which is incorporated herein by reference, in its entirety:

Manson et al., U.S. Provisional Patent Application Ser. No. 60/711,284, entitled “An Automated Method and Apparatus for Constructing Process Models and Managing their Synchronized Representations”, filed Aug. 24, 2005.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

Field of Invention

The present invention relates to natural language processing, the production of object models that mirror natural language, and the production of representations, such as diagrams, from natural language text descriptions. The present invention also relates to the production of textual descriptions of processes from the diagrammatic representations of the processes. The invention is more particularly related to a process modeling method for constructing a fundamental object structure from which a coordinated set of diverse representations may be uniformly generated.

### SUMMARY OF THE INVENTION

The present inventors have realized the need to automate the production of a coordinated set of textual and graphical representations of processes. The present inventors have invented and developed a system for constructing a semantic object network as the fundamental structure from which these representations are uniformly generated. At a minimum, and as only one example of utility, the present invention helps identify requirements errors and provides a visual reference for understanding textual descriptions of systems, software, and other processes.

The present invention is a significant expansion of the techniques and processes described in Manson, U.S. patent application Ser. No. 09/883,693, filed Jun. 18, 2001, the contents of which are incorporated herein by reference in their entirety. The present invention is both an expansion of the syntactic and semantic representation mechanisms of Manson as well as an expansion of the utility for a user of a computer system equipped with the modeling capability. The present invention is not limited to the object model produced using Manson. Other methods of producing an object model may be utilized, including the adaptive method presented here.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a block diagram of the components and communications within an architecture according to an embodiment of the present invention;

FIG. 2 is a screen shot of a user interface according to an embodiment of the present invention;

FIG. 3 is a screen shot of a dialog box for manual type assignment according to an embodiment of the present invention;

FIG. 4 is an illustration of a syntactic dependency structure (parse tree) according to an embodiment of the present invention;

FIG. 5 is a screenshot of a project hierarchy according to an embodiment of the present invention;

FIG. 6 is a screenshot of a project glossary according to an embodiment of the present invention;

FIG. 7 is an example of annotated text according to an embodiment of the present invention;

FIG. 8 is an example of an activity diagram according to an embodiment of the present invention;

FIG. 9 is an example of a use case diagram according to an embodiment of the present invention;

FIG. 10 is a screen shot of an object relationship diagram according to an embodiment of the present invention;

FIG. 11 is a screen shot of an object network map diagram according to an embodiment of the present invention;

FIG. 12 is a screen shot of an activity schedule diagram according to an embodiment of the present invention;

FIG. 13 is a screen shot of an action paradigm schema diagram according to an embodiment of the present invention;

FIG. 14 is a screen shot of an actor/object list diagram according to an embodiment of the present invention;

FIG. 15 is a screen shot of an object manager diagram according to an embodiment of the present invention;

FIG. 16 is a screen shot of a text/object linking diagram according to an embodiment of the present invention;

FIG. 17 is a screen shot of an object/object linking diagram according to an embodiment of the present invention;

FIGS. 18A and 18B are flow diagrams of an overview of processing,according to an embodiment of the present invention;

FIGS. 19A and 19B are flow diagrams of an example interaction between a user, text processing, and lexicon manager according to an embodiment of the present invention.

FIG. 20 is a flow diagram of a syntactic processor according to an embodiment of the present invention;

FIG. 21 is a flow diagram of a semantic processor according to an embodiment of the present invention;

FIG. 22 is an example of an external processing module according to an embodiment of the present invention; and

FIG. 23 is an example of a rendering process module according to an embodiment of the present invention.

### DESCRIPTION OF THE PREFERRED EMBODIMENTS

The following is a description of specific applications of a process modeling method which incorporates a sequence of discrete steps detailed in the subsections below. In summary, the described method constructs a semantic object network as the fundamental structure from which a coordinated set of textual and graphical representations are uniformly generated, and hence, automatically synchronized. Although this description is presented in a manner which strongly suggests that natural language text is an originating representation from which all other representations are constructed, it is important to realize that the method described below conforms to an MVC (Model/View/Controller) architecture, in which all of the representations (views) may be used (controlled) to manage the underlying network (model).

1) System Architecture:

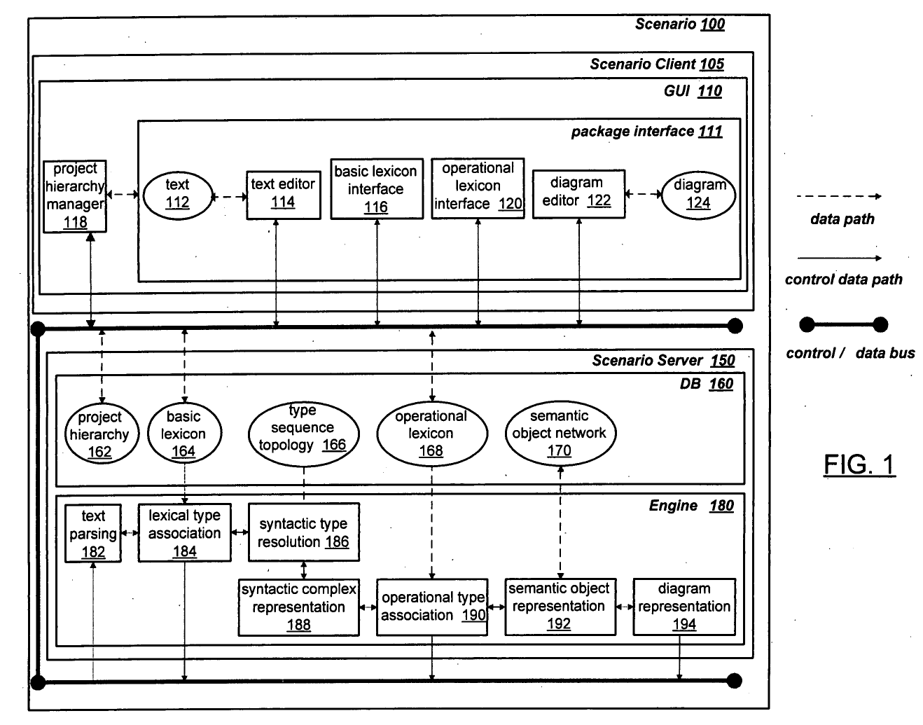

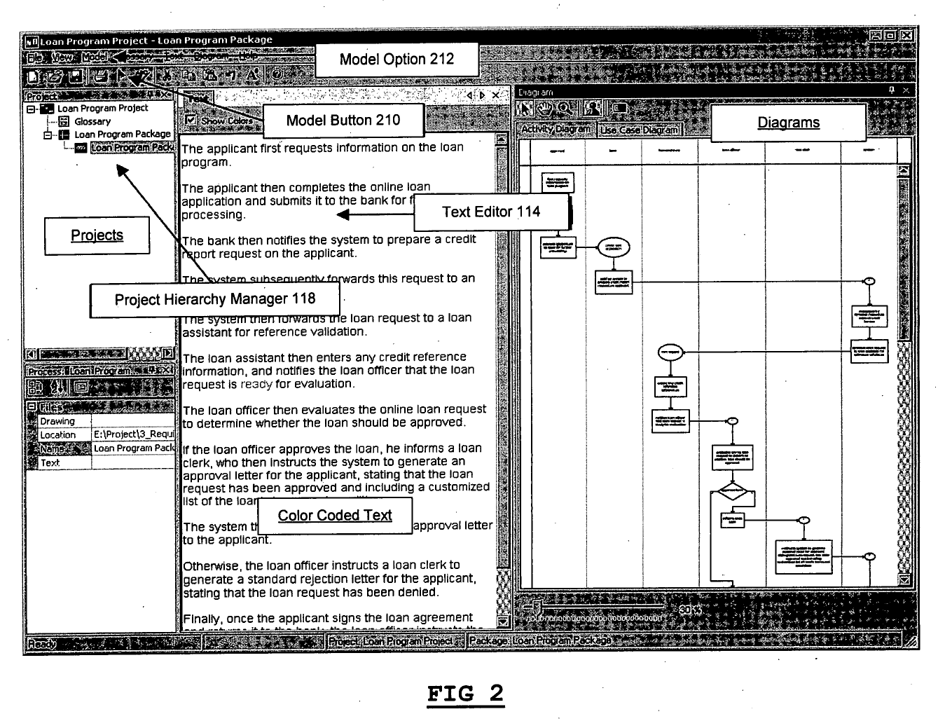

The preferred implementation of this process modeling method is manifested in a computer system called “Scenario,” which will be referenced by that name in what follows. Referring now to the drawings, wherein like reference numerals designate identical or corresponding parts, and more particularly to FIG. 1 thereof, there is illustrated a block diagram of components and communications of an architecture according to an embodiment of the present invention (see Scenario 100 in FIG. 1). More specifically, Scenario 100 is functionally divided into a client component 105 (also called “Scenario Client”) and a server component 150 (also called “Scenario Server”), though this division does not necessarily entail a physical division requiring separate hardware components. From this purely functional perspective, it is possible to emphasize certain useful distinctions in system behavior such as the following: Scenario Client 105 hosts the GUI 110 (Graphical User Interface, see FIG. 2) functions of the system, while Scenario Server 150 hosts background processing functions such as the engine 180 and the DB 160 (DataBase).

2) System Processing:

2.1) Syntactic Processing:

2.1.1) Text Editing:

In one embodiment, Scenario Client 105 provides a text editor 114 which is presented for use in a standard, windowed format (note 114 in FIG. 2). After a text 112 has been entered into this editor, the user activates process modeling. Scenario provides several alternatives, including:
pressing a model button 210 on the toolbar (FIG. 2);
selecting a model option 212 from a dropdown menu (FIG. 2); and
entering ctrl+m on the keyboard.

Scenario Client 105 then retrieves the entered text from the text editor 114 and forwards it to Scenario Server 150 for further syntactic and semantic processing (see engine 180).

2.1.2) Text Parsing:

At the beginning of this step in a Scenario modeling process, as activated through the text view (see Sec. 2.1.1), the entered text is represented as a sequence of ASCII characters. The text parsing module 182 of Scenario Server 150 transforms this ASCII character sequence input into a coherent sequence (narrative) of token sequences (sentences) by identifying words and punctuation symbols as presented in the entered text, and then arranging these basic syntactic elements into their proper sentential contexts (i.e., making a determination of where the word and sentence boundaries are). All manner of idiomatic syntactic constructions such as abbreviations, contractions, capitalizations, hyphenations, acronyms and initialisms are handled appropriately. For example, a contraction is expanded into its two individual word elements, an initialism is identified as a special lexical type (initialism), and so on.

Scenario Server then forwards the parsed narrative for further syntactic processing (see FIG. 1).

2.1.3) Basic Lexicon:

The basic lexicon 164 is an integral component of Scenario 100. It contains a list of basic lexical terms. A lexical term is a pair consisting of a natural language token (word or punctuation symbol) and a virtual lexical type (ambiguous grammatical designation).

2.1.4) Lexical Type Association:

As performed by Scenario Server, the process of lexical type association 184 matches each token in a narrative with its appropriate lexical type, in a manner consistent with the population of lexical terms found in the basic lexicon. This type assignment process is performed automatically for each recognized token (see Sec. 2.1.4.1), and performed manually for each unrecognized token (see Sec. 2.1.4.2).

2.1.4.1) Automatic Type Assignment:

Scenario Server 150 recognizes a token for automatic lexical type assignment. Token recognition is performed, for example, using one of the following characterizations:
indirect morphological inference; and
direct lexical reference.

Morphological inference depends on general suffix formation of a token, while lexical reference depends on specific string matching against entries in the basic lexicon. In either case, each recognized token in a narrative is paired with an appropriate virtual lexical type to form a lexical term.

2.1.4.2) Manual Type Assignment:

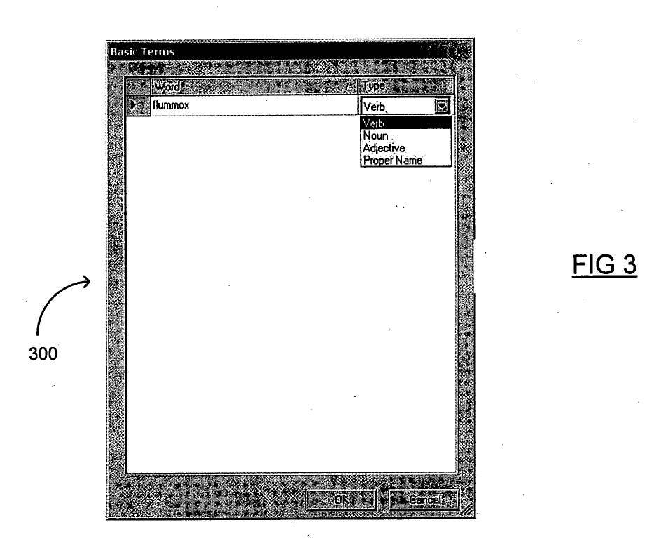

If Scenario Server 150 does not recognize a token for automatic lexical type assignment, it alerts Scenario Client 105 to query the user for an appropriate lexical type assignment. In this case, Scenario Client 105 then launches the basic lexicon 116 interface, which presents the user with a dialogue box 300 (see FIG. 3) in which to select a type assignment for each unrecognized token in the current narrative. The choices for lexical type assignment presented in this way are limited, but generous enough in scope to cover all relevant syntactic contingencies in standard usage. The lexical type choices are, for example, verb, noun, adjective, and proper name.

Upon performing the required lexical type assignments for all tokens in the narrative being modeled, Scenario Server 150 has transformed a sequence of token sequences into a sequence of associated lexical term sequences, which it passes downstream for further syntactic processing.

2.1.5) Syntactic Type Resolution:

Scenario Server 150 resolves each virtual lexical type in a given sequence of lexical terms (corresponding to a sentence in a processed narrative) by interweaving the subprocesses of type refinement and type reduction in the process of syntactic type resolution 186.

2.1.5.1) Type Refinement:

Using a weighted, smoothed metric defined on an optimally dimensioned topological space of reduction type sequences (the type sequence topology 166), Scenario Server 150 refines each virtual lexical type embedded in a given lexical type sequence into an actual lexical type by means of a series of local type assignments determined by the specific syntactic context constituted by the embedding type sequence. See Example 1 for a specific example of how this works. The optimal dimension for the topological space has been determined empirically.

2.1.5.2) Type Reduction:

Using a priority scheme induced by the composition of a type rank matrix and a type order matrix operating on the space of lexical type pairs, Scenario Server 150 reduces each pair of adjacent, fully refined types appearing in a given lexical type sequence into a remaining dominant type and a suppressed subordinate type.

Example 1 shows in more detail how the matrices and topology work step by step to effect the type resolution in the preferred embodiment.

Upon performing the required type resolutions for all terms in the narrative being modeled, Scenario Server 150 has transformed a sequence of virtual type sequences into a sequence of associated resolved type sequences with complete syntactic dependency characteristics, which it passes downstream for further syntactic processing (see FIG. 1).

2.1.6) Syntactic Complex Representation:

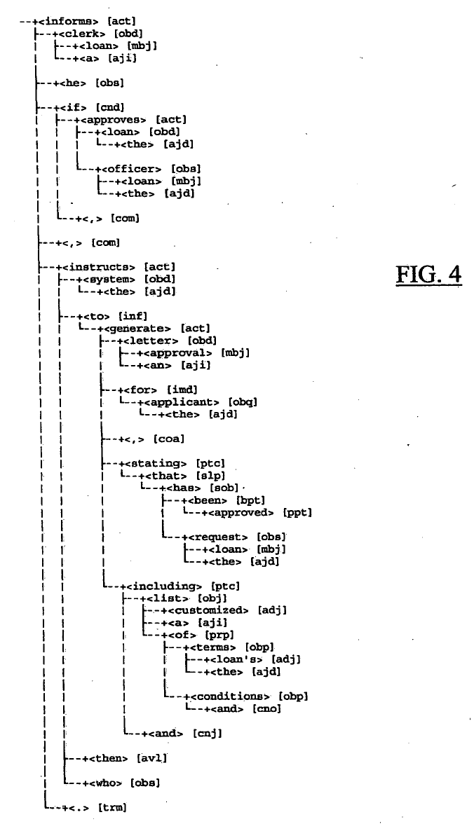

Using the complete syntactic dependency relations induced by full type resolution (see Sec. 2.1.5), Scenario Server 150 constructs a coherent syntactic complex representation of the originating narrative (see syntactic complex representation 188). FIG. 4 is an illustration of a syntactic dependency structure (parse tree) according to an embodiment of the present invention. As shown in FIG. 4, the representation is conveniently displayed as a system of associated parse trees. Notice that subtle syntactic distinctions such as the appropriate grammatical categorization of each noun into verb subject, direct object, indirect object, and prepositional object are made here.

Upon constructing the syntactic complex representation of the narrative being modeled, Scenario Server 150 passes it downstream for initial semantic processing.

2.2) Semantic Processing:

2.2.1) Operational Hierarchy:

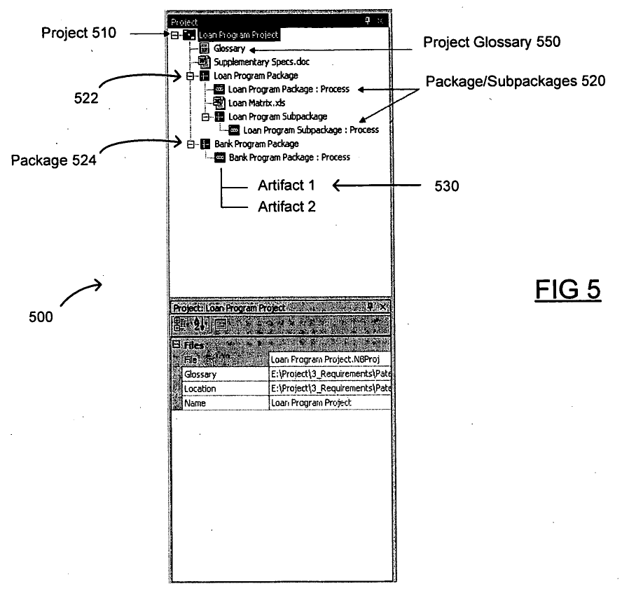

FIG. 5 is a screenshot of a project hierarchy according to an embodiment of the present invention. As shown in FIG. 5, Scenario Server 150 organizes semantic object networks 500 in a nested, descending project/package/artifact hierarchy (e.g., project 510, packages 520, and artifacts 530), simply called the project hierarchy 162 for convenience. The user manages the project hierarchy 162 through the project hierarchy manager 118. The project hierarchy manager 118 is accessible, for example, via the user interface shown in FIG. 2.

An artifact (e.g., artifact 530) is either some semantic object network representation (textual or graphical) or a related miscellaneous item such as an ancillary document.

A package (e.g., package 524) is a collection of artifacts and subpackages (e.g., process 524) associated with a single semantic object network. The user manages packages through the package interface 111.

A project 510 is a collection of packages (e.g., packages 522/524), associated with a common operational lexicon (or project glossary 550, see Sec. 2.2.2 for further details).

2.2.2) Operational Lexicon:

Scenario Server 150 associates an operational lexicon 168 with each project. For example, the operational type association 190 makes the association (see Sec. 2.2.1). An operational lexicon contains all operational terms which appear in the associated project narratives. An operational term is a pair consisting of a natural language token and an operational type. The operational types recognized by Scenario Server are:
function;
system;
actor;
object;
modifier; and
null.

A function is an action performed by some agent, which is either some system component or some other type of actor. An object is any entity upon which (or relative to which) some agent acts by means of some function. A modifier is a term which attributes special properties to an action or an object. System and actor are agents, and null is an operational type that is not any of the other types.

Note, under this definition, that any agent, whether system or actor, is an object of a special kind. It is often useful to distinguish these agents as active objects, as opposed to passive objects which are simply transferred between agents or submitted to some action by an agent.

Clearly, there is a strong correlation between syntactic terms and operational terms under which:
active verbs are cast as functions;
verb subjects are cast as actors;
direct, indirect, and prepositional objects are cast as objects; and
adverbs and adjectives are cast as modifiers

Scenario Server 150 vigorously exploits this correlation in generating the semantic connection between syntactic structure and object structure (see Sec. 2.2.3). The fundamental unit of this connection is the action paradigm, which relates an actor to its function with respect to some object in accordance with an appropriate instrumentality (direction of object flow). The basic role of a modifier here is to transform relatively simple terms into relatively complex terms, so that functions and objects (including actors) may be endowed with unlimited articulation. For example, an “application” object becomes a “loan application” object by binding the modifier “loan” to the object “application.”

2.2.3) Operational Type Association:

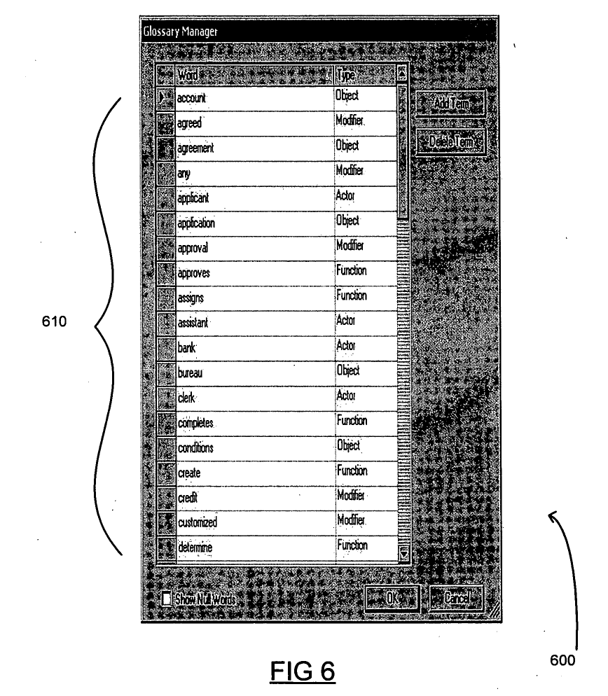

Using the syntactic object representation induced by full type resolution (see Sec. 2.1.5) and the strong correlation between syntactic terms and operational terms (see Sec. 2.2.2), Scenario Server 150 determines the appropriate operational type of each token in a processed narrative, automatically assigns this type in order to form an operational term associated with that token, and enters this term in the operational lexicon associated with the project in which that narrative appears (e.g., via operational type association 190). In this way, a processed narrative becomes a coherent sequence of operational term sequences, and the operational lexicon becomes a specialized project glossary for that supervening project domain (e.g., see FIG. 6, project glossary 610).

Under certain circumstances, the user may choose to override an automatic operational type assignment made by Scenario Server 150, and may do so by modifying the project glossary directly through the operational lexicon interface 120 of Scenario Client 105. A prime example of such a manual override is the promotion of a generic actor to a system agent, or the promotion of a generic object to an actor of some sort.

2.2.4) Semantic Object Representation:

Using the relative operational term structures induced by syntactic object representations augmented by corresponding operational type assignments (see Sec. 2.2.3), Scenario Server 150 constructs a semantic object representation of a processed narrative (see semantic object representation 192) which includes:
static characteristics;
dynamic characteristics; and
logical characteristics

The static characteristics include
process actors and their attributes;
process objects and their attributes; and
passive relationships between process actors/objects

The dynamic characteristics include
functional relationships on/between process actor; and
transfers of control/object between process actors.

The logical characteristics include:
conditional relationships on/between process actors; and
faithful representations of the propositional calculus.

From a technical (model-theoretic) perspective, a semantic object representation of a narrative is basically a many-sorted first-order model of the theory comprised by the sentences of the narrative.

This local representation is stored and managed in the Scenario Server DB 160 as a substructure of the semantic object network 170.

2.2.5) Textual and Graphical Representation:

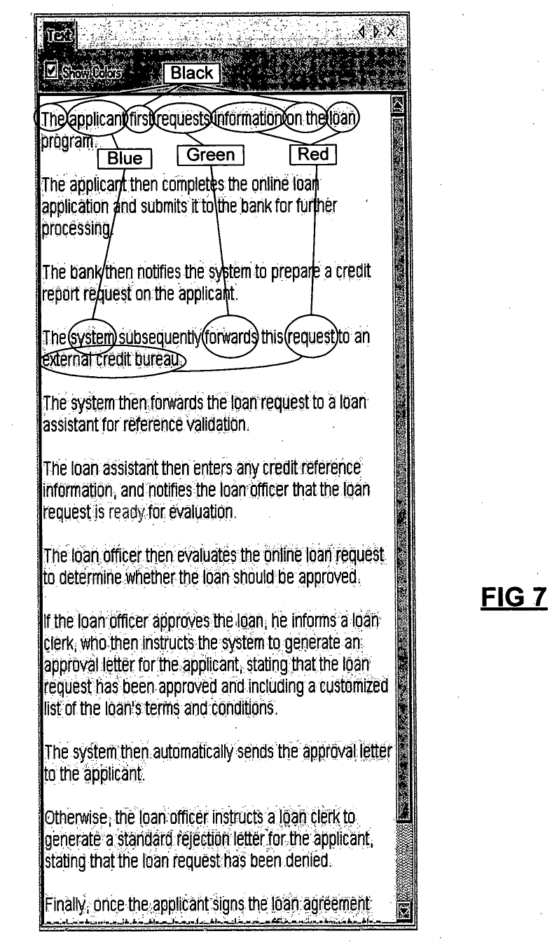

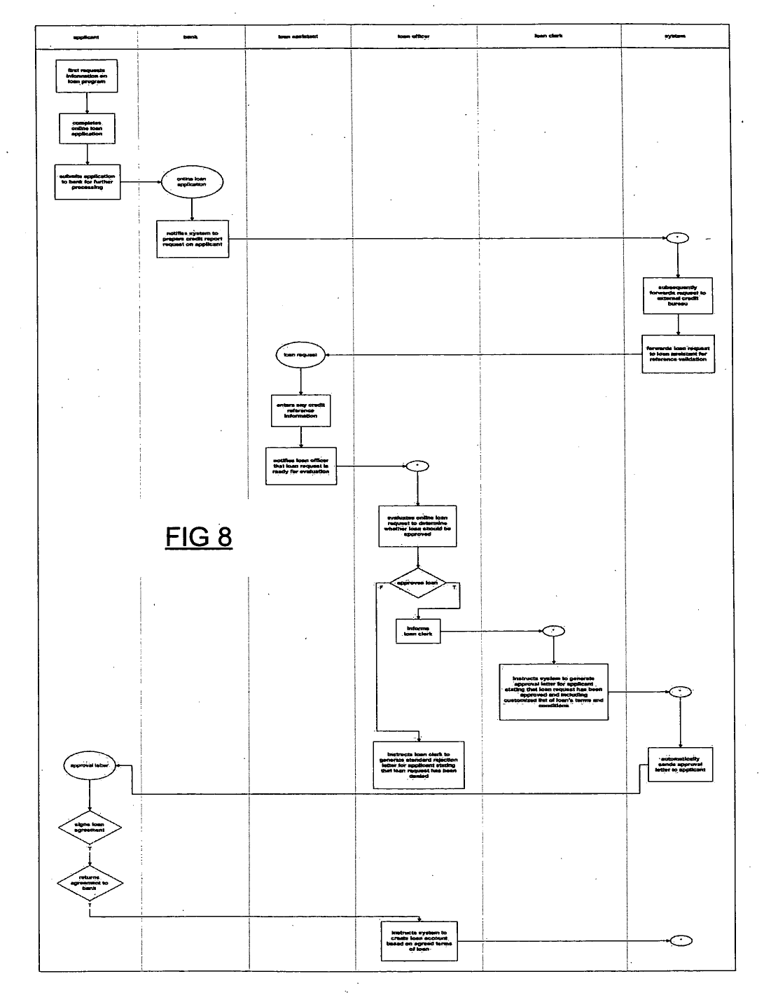

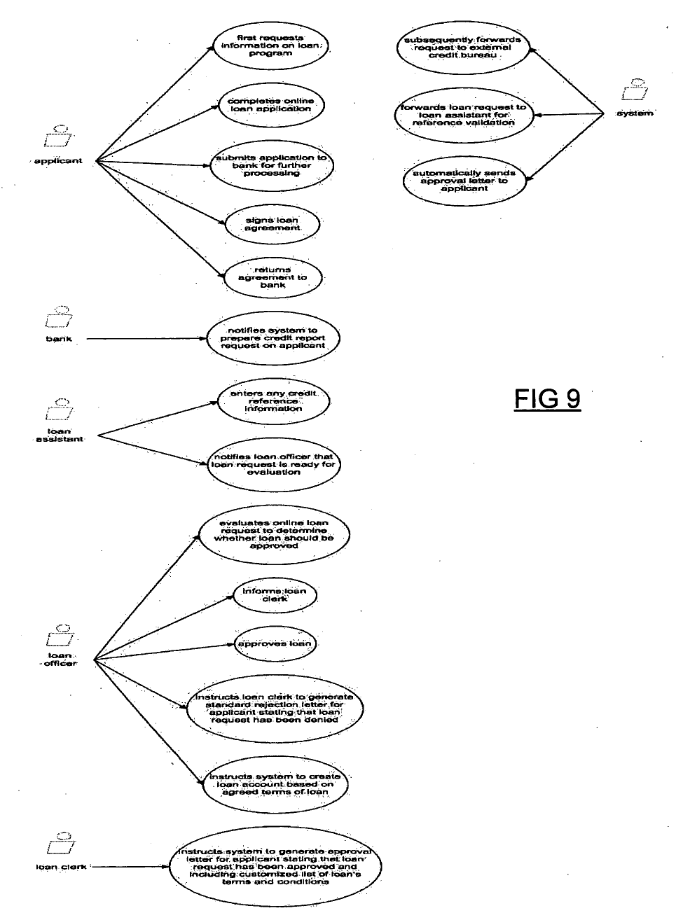

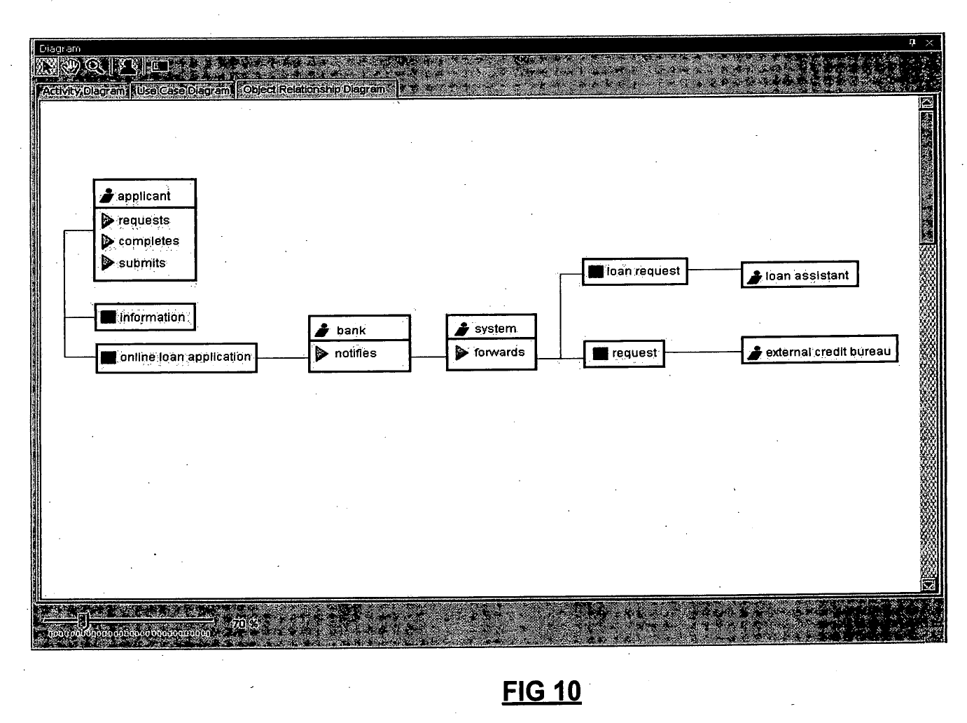

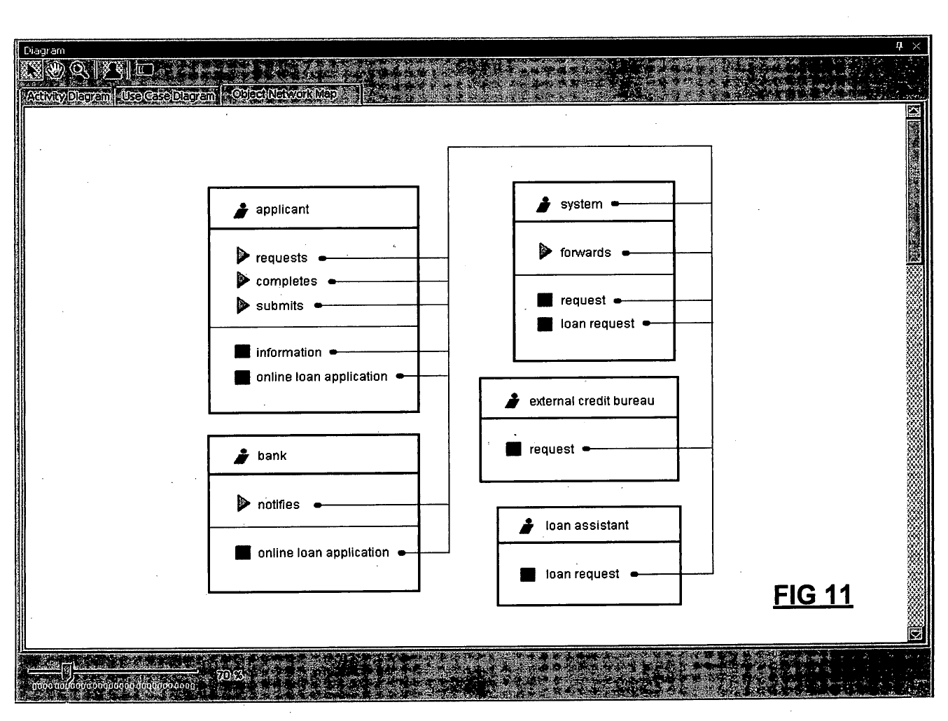

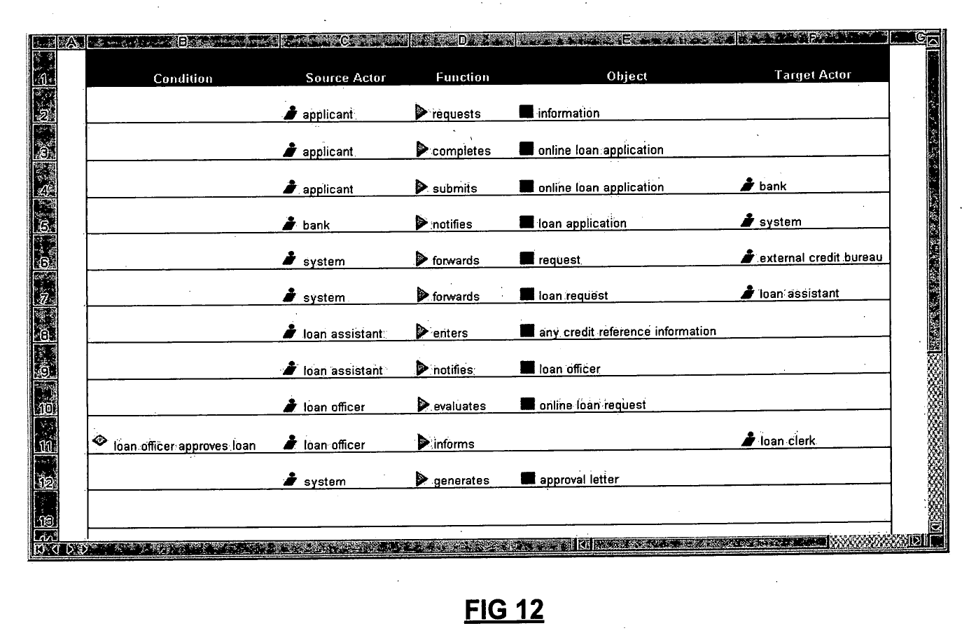

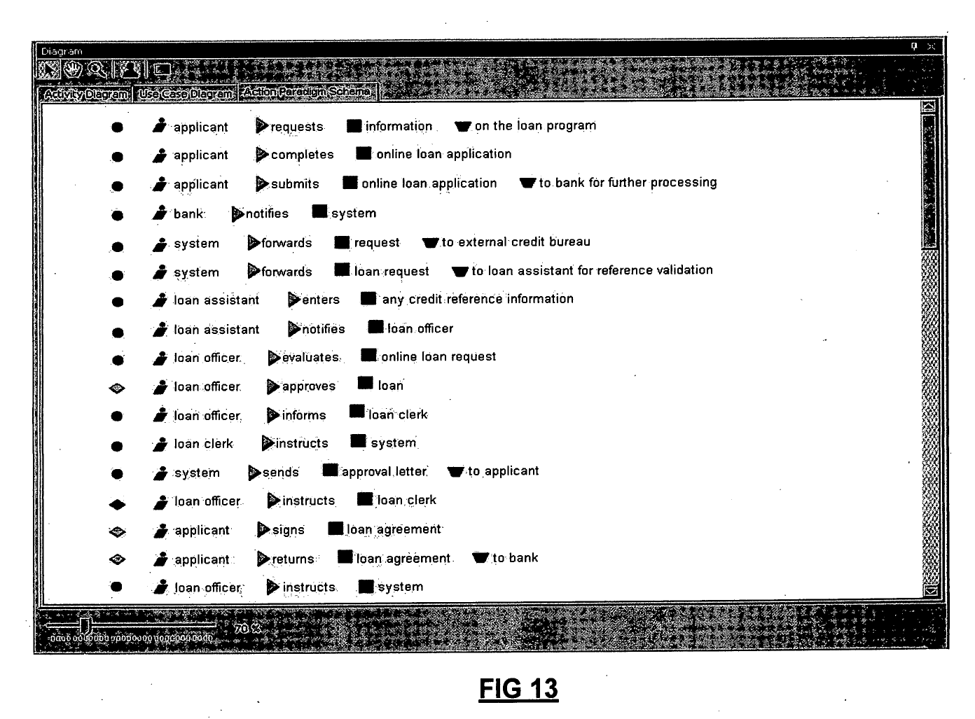

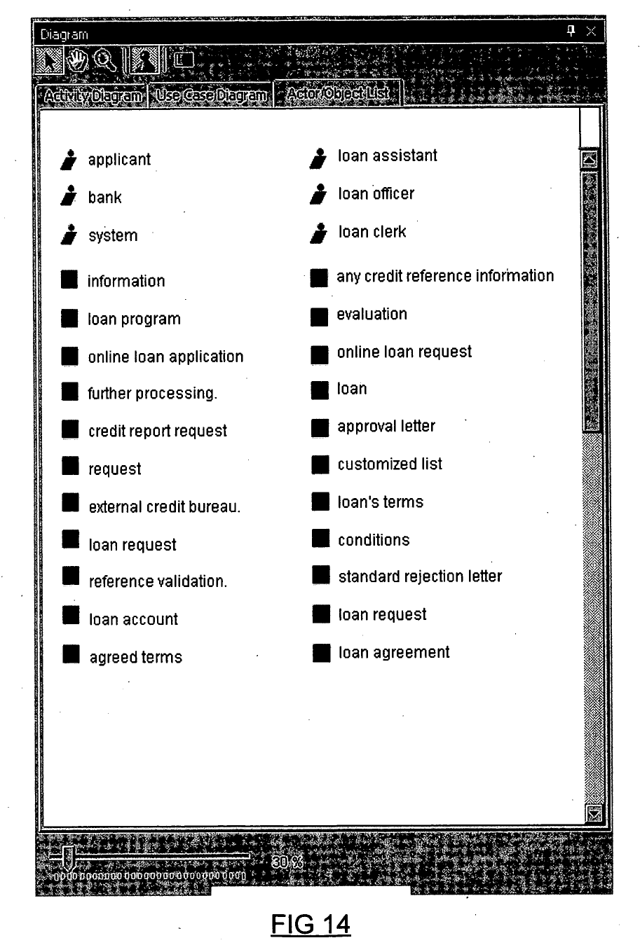

Using the semantic object representation (model) of a processed narrative generated in accordance with its appropriate operational term structures (see Sec. 2.2.4), Scenario Server 150 constructs various textual and graphical representations (views) of the semantic structures associated with that narrative. The diagram representation 194 performs the constructions. The representations include:
annotated text (see FIG. 7);
activity diagram (FIG. 8);
use case diagram (see FIG. 9);
object relationship diagram (FIG. 10);
object network map (see FIG. 11);
activity schedule (see FIG. 12);
action paradigm schema (FIG. 13); and
actor/object list (FIG. 14).

Each of these representations is transferred to Scenario Client 105 for display in the GUI (e.g., diagram 124), and the user manages each of them through the diagram editor 122.

It is here that the MVC architecture of Scenario becomes especially operative, in that any modification made to any of these visual representations results in a corresponding modification of the underlying semantic object network 170, which then synchronously becomes reflected in each of the Scenario representations, textual and graphical, of that modified network.

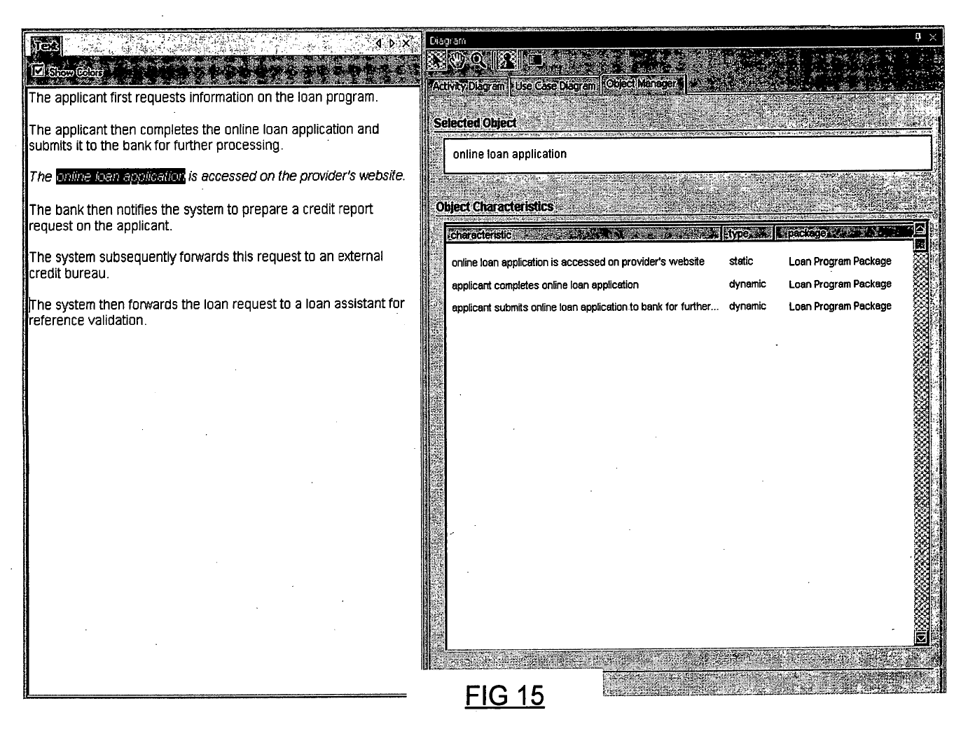

In particular, the characteristics of any object (passive or active) in the semantic network may be effectively viewed and controlled through its appropriate representations. The internal characteristics of an object may be accessed through any of the model representations listed above. The characteristics are accessed, for example, by selecting the object as it appears in a representation and activating the object manager. FIG. 15 is a screen shot of an object manager diagram according to an embodiment of the present invention. External characteristics such as relationships may be accessed through the object relationship diagram or the object network map, in which these relationships are clearly displayed, hence easily modified.

2.2.6) Representation Linking:

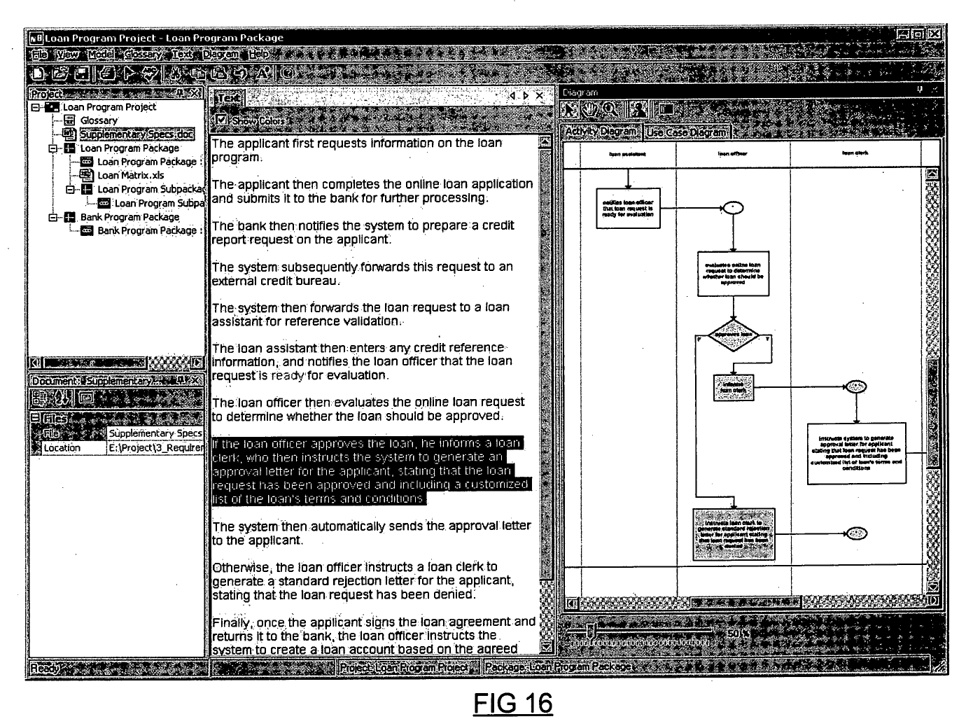

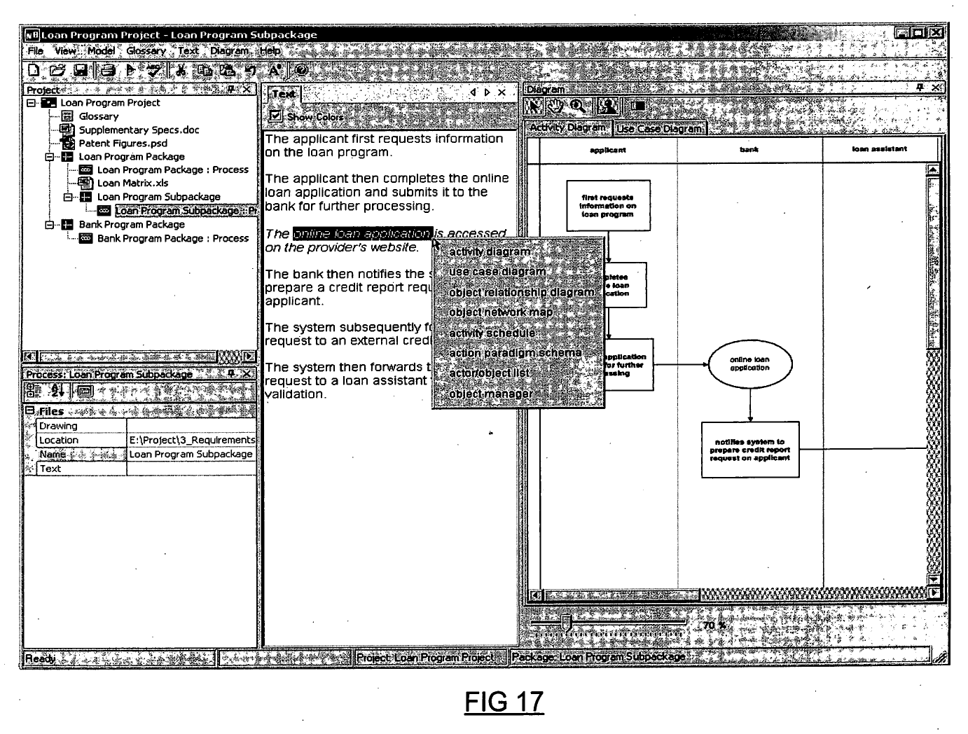

It is important to note that the underlying model from which all the textual and graphical representations are generated by Scenario (see Sec. 2.2.5) provides an effective basis upon which all entities may be automatically linked across all representations. In particular, any text fragment in a narrative is automatically linked with all of its representational components in each of these views, and the Scenario user is able to activate these links as soon as the model is generated (e.g. see FIG. 16). Automatic links between corresponding components in any pair of these views are similarly generated, and hence, immediately accessible (e.g. see FIG. 17).

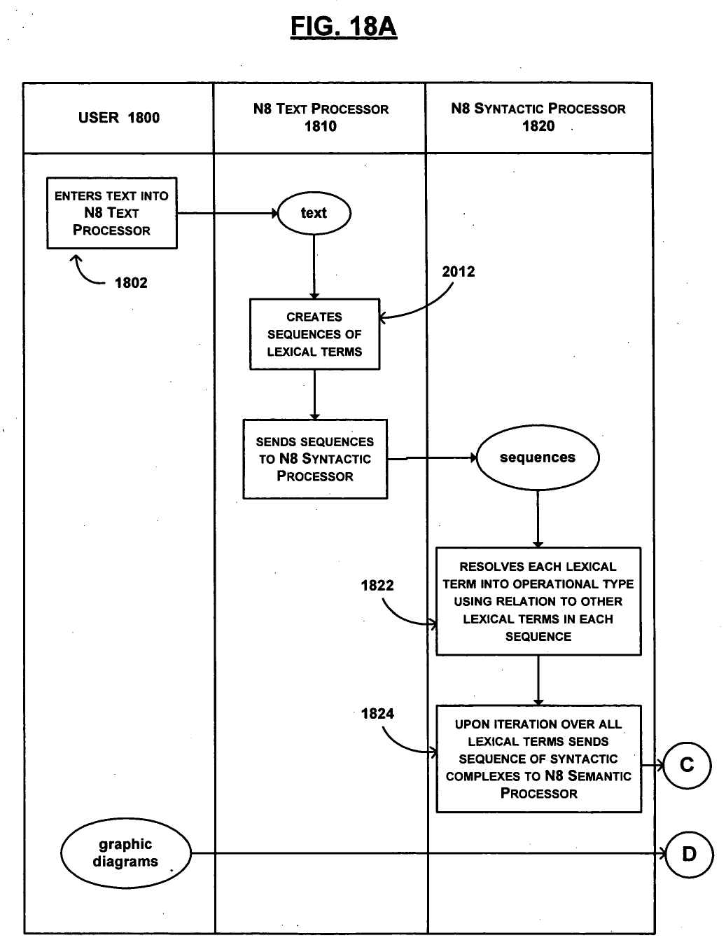

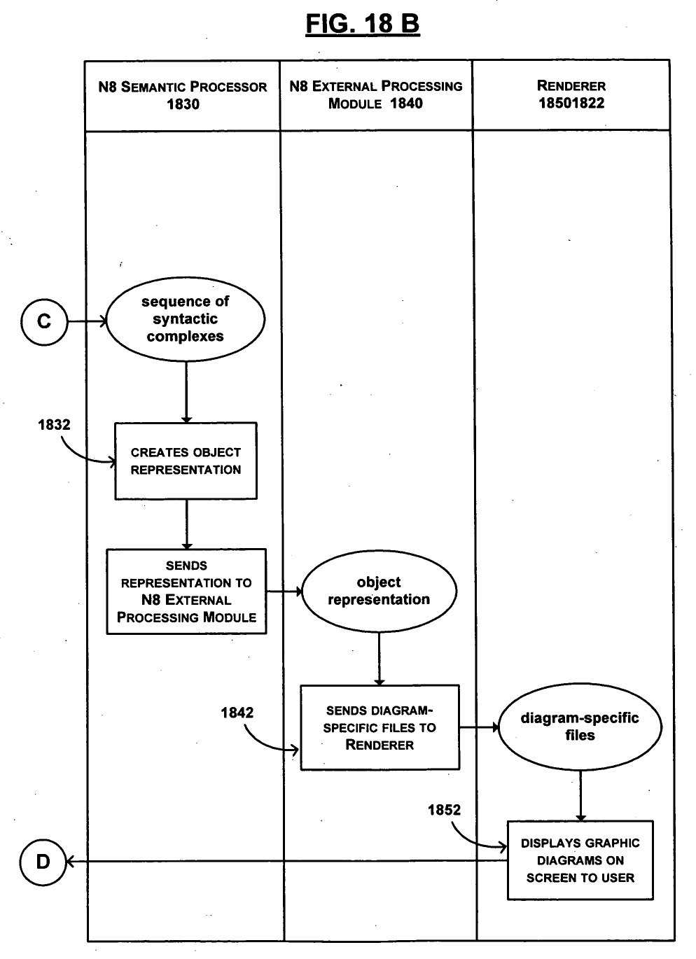

FIGS. 18A and 18B are flow diagrams of an overview of processing according to an embodiment of the present invention. The user 1800 enters text 1802, and the text processor 1810 creates a sequence of lexical terms 1812. The sequence of lexical terms 1812 are resolved into operational types 1822 and iterated 1824 to produce a sequence of syntactic processes. The semantic processor 1830 creates object representations 1832. An external processing module 1840 prepares and sends diagram specific files 1842 to the renderer 1850 which displays graphic diagrams on screen 1852 to the user 1800.

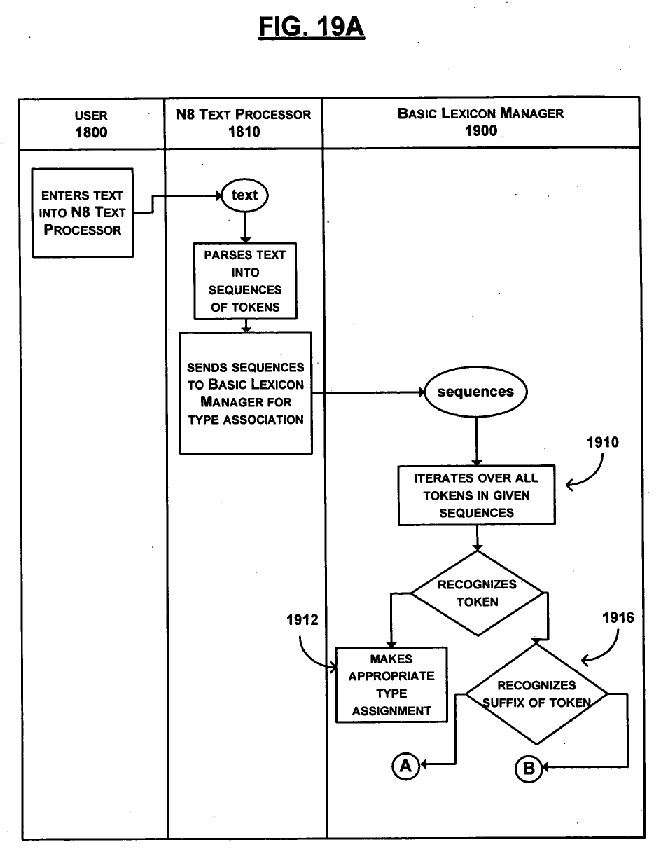

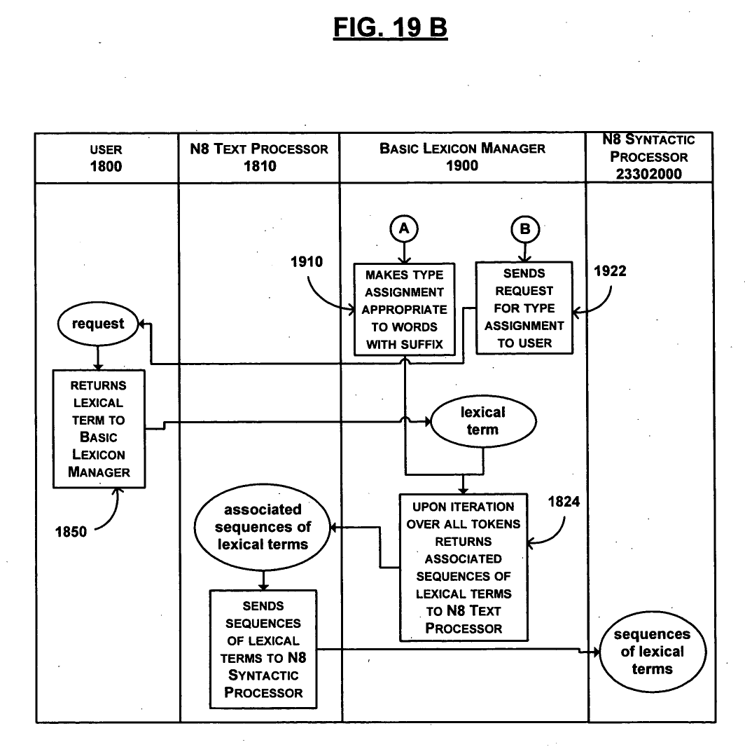

FIGS. 19A and 19B are flow diagrams of an example interaction between a user, text processing, lexicon manager, and syntactic processor according to an embodiment of the present invention. The text processing is, for example, the text processor discussed above. The text processor 1810 parses the received text into sequences of tokens which are sent to the basic lexicon manager 1900. The basic lexicon manager iterates over all tokens in given sequences 1910. Recognized tokens are assigned an appropriate type 1912. Unrecognized tokens may be recognized via a suffix of the token 1916; if so, a type assignment is made based on the suffix 1920. Unrecognized tokens with unrecognized suffixes are sent to a manual assignment method. In this example, the manual assignment method is requesting the user 1922 to assign a lexical term 1850 to the unrecognized token. Upon iteration over all tokens, the text processor 1810 sends the sequences of lexical terms to the syntactic processor 2000.

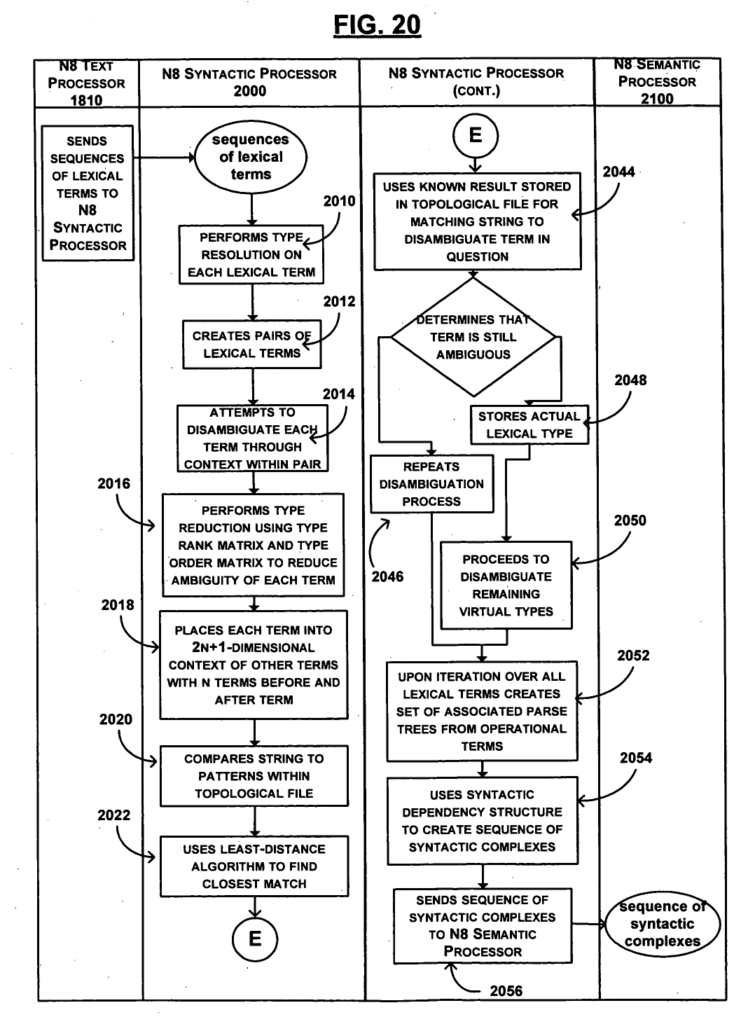

FIG. 20 is a flow diagram of a syntactic process according to an embodiment of the present invention. Upon receipt of the sequences of lexical terms, the syntactic processor performs a number of sub-processes as shown in the flow chart. A sequence of syntactic complexes is created which are forwarded for semantic processing (to semantic processor 2100).

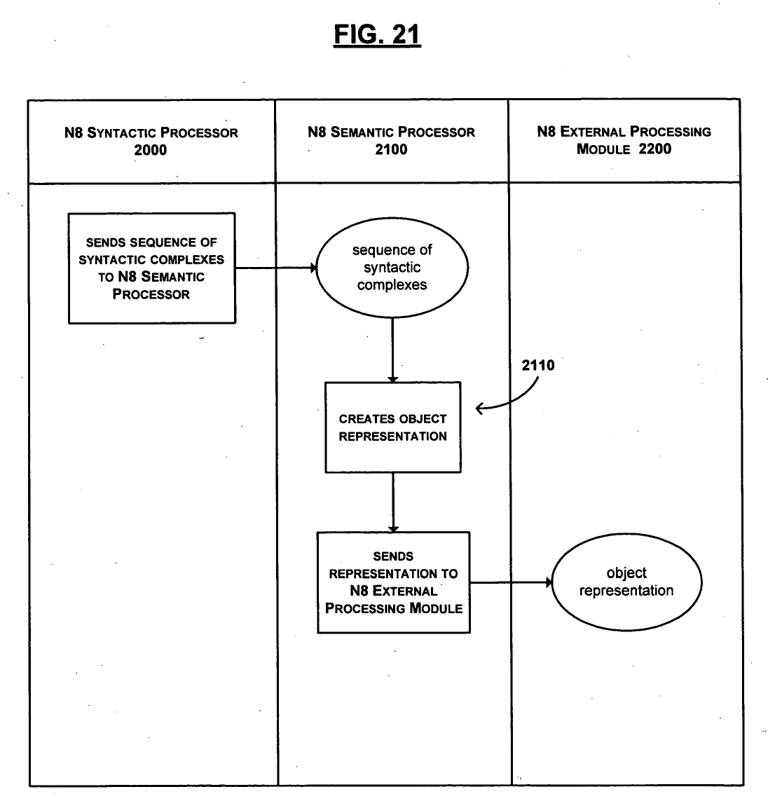

FIG. 21 is a flow diagram of a semantic process according to an embodiment of the present invention. A semantic processor 2100 receives syntactic complexes from syntactic processor 2000 and creates an object representation 2110, which is forwarded to, for example, an external processing module 2200.

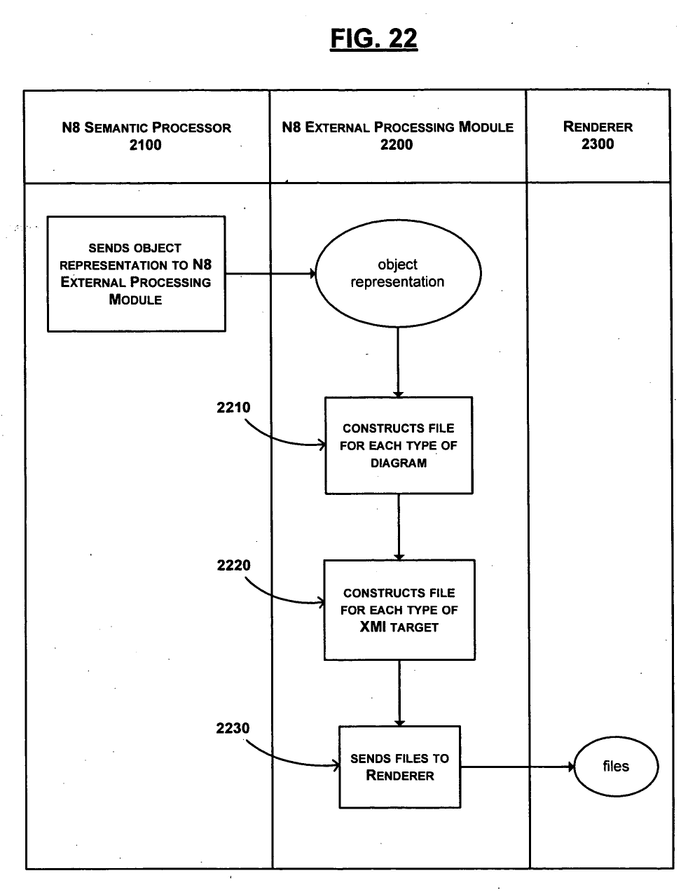

FIG. 22 is an example of external processing according to an embodiment of the present invention. An external processing module 2200 constructs a file for each type of diagram 2210, and for each target 2220. The constructed files are forwarded to a renderer 2300.

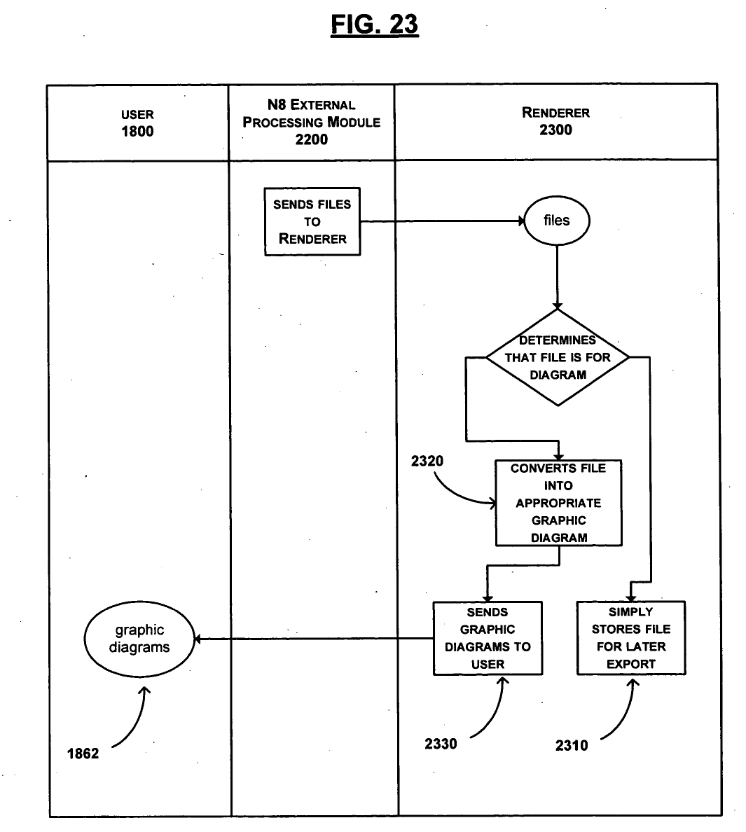

FIG. 23 is an example of a rendering process according to an embodiment of the present invention. The renderer 2300 stores the files for later export 2310 if not diagrammed. Otherwise, the file is converted into an appropriate graphic diagram 2320 which are sent to the user 2330 for display as graphic diagrams 1862.

Thus, the present invention provides various techniques and processes for preparing diagrams from text and modifying text by changing diagrams. In one embodiment, the present invention comprises a method, comprising the step of generating graphical representations of an object model. The object model is, for example, created from natural language text via an adaptive syntactic pattern recognition scheme. In one alternative embodiment, the method includes the step of constructing the graphical representations of an object model via a semantic object representation method. The semantic object representation model, for example, comprises, preparing a semantic object representation comprising a prepared syntactic complex augmented by an operational type association method comprising, determining an operational type assignment method based on a lexical type signature of a given token of an operational lexicon, and performing an operational type association comprising forming an operational term by applying the determined operational type assignment method.

Various alternative embodiments include the step of automatically linking correlated object elements across all representations generated, and/or any of linking object elements in graphical representations produced by a semantic object representation method, linking object elements in textual representations produced from an object model as produced by a semantic object representation method, and linking object elements in graphical representations produced by a semantic object representation method with correlated object elements in textual representations produced from an object model as produced by a semantic object representation method.

Other alternative embodiments include the step of interactively presenting the graphical and textual representations as views, wherein the graphical and textual representations comprise an underlying semantic object model; and controlling the graphical representation by direct manipulation of the object model. The underlying semantic object model is produced, for example, by preparing a semantic object representation comprising a prepared syntactic complex augmented by an operational type association method, and the operational type association method comprises, for example, determining an operational type assignment method based on a lexical type signature of a given token of an operational lexicon, and performing an operational type association comprising forming the operational term by applying the operational type assignment method.

In various embodiments, graphical representations comprise, for example, any of an activity diagram, a use case diagram, an object relationship diagram, an object network map, an activity schedule, an action paradigm schema, and an action/object list.

In another embodiment, the present invention alternative embodiment, the invention is a method comprising the step of generating graphical representations of an object model, wherein the object model is created from natural language text via an adaptive syntactic pattern recognition scheme. The invention may also include the steps of, creating syntactic type representations of the natural language text, and storing the syntactic type representations in a remodeling cache.

In various embodiments, the invention may include, for example, the step of exporting the representations of the object model, wherein the exported representations are formatted in any of XMI, XML, BPEL, and Microsoft Visio protocols. The various embodiments may also alternatively include the steps of, displaying the representations of the object model in Microsoft Visio, and exporting the representations of the object model, wherein the exported representations are formatted in, for example, Microsoft Visio or another protocol. The exported representations of the object model may be formatted, for example, in any of .bmp, .jpg, gif, .png, .tiff, .exif, .wmf, and .emf protocols.

In another embodiment, the present invention is a method, comprising the step of generating textual representations of an object model. The object model is, for example, created from natural language text via an adaptive syntactic pattern recognition scheme. In one embodiment, the method includes the step of constructing the textual representations from an object model produced by a semantic object representation method. The textual representations comprise, for example, an annotated text, with graphical marking of tokens indicating proper operational type associations. The proper operational type associations comprise, for example, determining an operational type assignment method based on a lexical type signature of a given token of the operational lexicon, and performing an operational type association comprising forming the operational term by applying the operational type assignment method.

In another embodiment, the present invention is a method comprising the step of creating a basic lexicon. The basic lexicon is, for example, a lexicographically ordered list of lexical terms, where a lexical term is a pair consisting of an admissible token and an associated lexical type, a token is a string of ASCII characters, an admissible token is a token which is either a word or a punctuation symbol in a natural language, and a lexical type is a syntactic designation which specifies the possible grammatical roles its associated token can assume in a sentential context relative to that natural language. In one alternative, the method includes the steps of viewing a lexical term in the basic lexicon, inserting a lexical term into the basic lexicon, editing a lexical term in the basic lexicon, deleting a lexical term from a basic lexicon. In another alternative, the method may include a step of assigning a lexical type, which forms one of the lexical terms, using a submethod of direct lexical reference to the basic lexicon or a submethod of indirect morphological inference on token suffix formation or a submethod of manual selection from a list of lexical types or by applying an appropriate lexical type assignment method. An appropriate assignment method is, for example, determined by a character string signature of a given token.

In another embodiment, the present invention in a method for lexical type resolution comprising the step of transforming a virtual type occurring in a lexical type sequence into an actual type, where a virtual lexical type is an ambiguous designation of grammatical role allowing for a number of possible outcomes in sentential context, and an actual lexical type is a fixed designation of grammatical role.

In another embodiment, the present invention is a method comprising the step of creating a type reduction rank matrix, which is a reduction priority structure operating on the space of pairs of actual lexical types. In another embodiment, the present invention is a method comprising the step of creating a type reduction order matrix, which is a reduction dominance structure operating on the space of pairs of actual lexical types.

In another embodiment, the present invention is a method comprising the step of defining a metric on a type sequence space by discrete convolution over at least one of a type reduction rank matrix, which is a reduction priority structure operating on the space of pairs of actual lexical types, and a type reduction order matrix, which is a reduction dominance structure operating on the space of pairs of actual lexical types, wherein a type sequence space is a set of lexical type sequences. The method includes, for example, the step of creating a type sequence topology of a space of lexical type sequences on which the metric has been defined. The method may further include the step of correlating any element of the type sequence topology with an associated lexical type, wherein the associated lexical type is the relative resolution value of the correlated element. In one alternative, the method further includes the step of performing syntactic refinement, by assigning a relatively resolved lexical type to an unresolved lexical type in a type sequence, and using a type correlation specifically determined by an optimization over the created type sequence topology.

In another embodiment, the present invention is a method for syntactic type reduction, comprising the steps of, selecting an adjacent pair of fully resolved types according to the type reduction rank matrix, and transforming the adjacent pair of fully resolved types in a type sequence into a remaining dominant type and a suppressed subordinate type, wherein the transformation is based on a type reduction rank matrix comprising a reduction priority structure operating on the space of pairs of actual lexical types.

In one alternative, the present invention includes the step of, performing lexical type sequence resolution by iterated lexical type resolution, incorporating submethods comprising, performing syntactic refinement, by, assigning a relatively resolved lexical type to an unresolved lexical type in a type sequence, and using a type correlation specifically determined by an optimization over the created type sequence topology, performing syntactic type reduction, comprising the steps of, selecting an adjacent pair of fully resolved types according to a type reduction rank matrix, and transforming the adjacent pair of fully resolved types in a type sequence into a remaining dominant type and a suppressed subordinate type, wherein the transformation is based on the type reduction rank matrix comprising a reduction priority structure operating on a space of pairs of actual lexical types, and wherein lexical type sequence resolution by iterated lexical type resolution in an interwoven application which transforms any sequence of lexical types into a correlated sequence of actual types. And may also include the step of preparing a syntactic complex representation, which represents an actual lexical type sequence, where the syntactic complex is a syntactic dependency structure represented as a parse tree that encodes syntactic information required to perform further semantic processing.

In one embodiment, the present invention is a method comprising the step of creating an operational lexicon. The operational lexicon is, for example, a lexicographically ordered list of operational terms, where an operational term is a pair consisting of an operational token and an associated operational type, an operational token is an admissible token comprising either a word or a punctuation symbol in a natural language, and an operational type is a semantic designation which specifies the operative role its associated token plays. The method may include, for example, the step of managing the operational lexicon by any of viewing an operational term in the operational lexicon, and/or inserting an operational term into the operational lexicon, and/or editing an operational term in the operational lexicon, and/or deleting an operational term from the operational lexicon. The step of managing may also include one or more of submethods such as direct lexical reference to the operational lexicon, indirect syntactic inference on a lexical type of a given token, manual selection from a list of operational types, based on lexical type signature of a given token. The invention may also include selecting between the various submethods based on any criteria and applying the selected submethod.

The present invention may also include, for example, preparing a semantic object representation comprising the prepared syntactic complex augmented by an operational type association method. In one alternative, the operational type association method comprises, determining an operational type assignment method based on a lexical type signature of a given token of the operational lexicon, and performing an operational type association comprising forming the operational term by applying the operational type assignment method. The operational type association method may include for example a step any of, for example, assigning static characteristics of an operative scenario, such as actors, objects, and passive relationships between actors and/or objects and other actors and/or objects, assigning dynamic characteristics of an operative scenario, such as functional relationships on and/or between actors, and transfers of control and/or objects between actors, and assigning logical characteristics of an operative scenario, such as conditional relationships on and/or between actors, and faithful representations of the propositional calculus.

In one embodiment, the present invention is a method for editing text, comprising, interactively displaying linking between the text and a diagram representation of the text. The diagram representation is, for example, a representation generated from graphical representations of an object model of the text. The graphical representations of an object model are produced, for example, by a semantic object representation method. The diagram representations comprise, for example, automatically linking object elements in graphical representations produced by a semantic object representation method with correlated object elements in textual representations produced from an object model of the text.

In another embodiment, the method for editing text comprises the step of interactively controlling representations from a text view as provided by a diagram representation method. The diagram representation method includes, for example, constructing graphical representations of an object model as produced by a semantic object representation method. In one embodiment, the text is annotated text. Any of the text editing methods may include, for example, the steps of interactively viewing the text, and interactively managing graphical representations as produced by the diagram representation method. Other steps that may be included are, for example, interactively displaying linking between diagrams and other representations as produced by the diagram representation method, and interactively controlling all representations from a diagrammatic view as provided by the diagram representation method.

In one embodiment, the present invention is a method, comprising the step of creating a project hierarchy. The project hierarchy is, for example, a nested data structure which organizes object model artifacts into packages, and packages into projects. The method may include, for example, the step of associating a basic lexicon with the project, and associating an operational lexicon with the project. Other steps may include, for example, the step of displaying graphical representations of projects, packages contained in the projects, and the artifacts of the packages, in a nested arrangement determined by the project hierarchy, the step of inserting a package into a project in the hierarchy, and the step of saving an existing package in a project in the hierarchy. An existing package may, for example, be renamed in a project in the hierarchy, moved to another project in the hierarchy, and/or deleted. The method may include, for example, the step of displaying artifacts of a selected package in the hierarchy may be displayed in graphical representations.

In another embodiment, the present invention is a method, comprising the steps of managing a package, comprising, for example, displaying artifacts of the package in graphical representations. The method may include, for example, any of the displaying a natural language text artifact of the package, displaying an activity diagram artifact of the package, displaying a use case diagram artifact of the package, displaying an object relationship diagram artifact of the package, displaying an object network map artifact of the package, displaying an activity schedule artifact of the package, displaying an action paradigm schema artifact of the package, displaying an actor/object list artifact of the package, displaying an annotated text artifact of the package, and modifying artifact graphical representations of the package, The modified artifact graphical representation is, for example, a natural language text artifact of the package, that includes any of an activity diagram artifact of the package, a use case diagram artifact of the package, an object relation diagram, artifact of the package, an object network map artifact of the package, an activity schedule artifact of the package, an action paradigm schema artifact of the package, an actor/object list artifact of the package, and an annotated text artifact of the package.

In another embodiment, the present invention is a method comprising the step of managing a package. The step of managing comprises, for example, saving artifacts of the package in the project hierarchy, including any of natural language text artifacts, activity diagram artifacts, use case diagram artifacts, object relationship diagram artifacts, object network map artifacts, activity schedule artifacts, action paradigm schema artifacts, actor/object list artifacts, and annotated text artifacts.

In one embodiment, managing a package comprises the step of modifying a representation of an object model associated with the package. The method may include, for example, the step of modifying characteristics of the object model from a natural language text artifact of the package. The modified characteristics include, for example, any of characteristics of the object model from an activity diagram artifact of the package, characteristics of the object model from a use case diagram artifact of the package, characteristics of the object model from an object relationship diagram artifact of the package, characteristics of the object model from an object network map artifact of the package, characteristics of the object model from an activity schedule artifact of the package, characteristics of the object model from an action paradigm schema artifact of the package, characteristics of the object model from an actor/object list artifact of the package, and characteristics of the object model from an annotated text artifact of the package. The method may also include, for example, the step of displaying automated links between artifacts of the package. The automated links include, for example, links between graphical artifacts of the package, links between textual artifacts of the package, and/or links between graphical and textual artifacts of the package.

In various embodiments, a displayed activity diagram and/or artifacts thereof may be viewed in a zoomable mode. Various embodiments may also include where the displayed artifacts comprise an activity diagram artifact of the package displayed in a pannable mode. Other modes include a scrollable mode, a pinned actor heading mode, a sequential presentation mode. In various embodiments, the same modes are applied to use case diagrams and their related artifacts, object network map artifacts (and may also include global mode, and a local, star topology mode), object relationship diagram artifacts of the package displayed in a zoomable mode (and may also include global and local, expanded attribute/method mode modes). The example also includes the step of printing each of the artifacts of the package as displayed, which may include, for example, the step of sizing panels of the printed artifacts such that a printed copy occupies sized panels and/or the provision of header/trimmer options to be used in the step of printing.

Various embodiments may also include the step of modifying an object model associated with a package according to a modification of any of the natural language text artifact of the package, the activity diagram artifact of the package, the use case diagram artifact of the package, the object relationship diagram artifact of the package, the object network artifact of the package, the activity schedule artifact of the package, the action paradigm artifact of the package, the action/object list artifact of the package, and the annotated text artifact of the package.

In other embodiments, links are utilized (e.g., automated linking), and the links are, for example, are activated and displayed.

In another embodiment, the present invention is a method, comprising the step of, diagramming natural language text, wherein the text is displayed and editable via a word processor, and resultant diagrams are displayed and editable via a diagram program. In one embodiment, the word processor comprises Word. In one embodiment, the diagramming program comprises Visio. In yet another embodiment, the diagrams are displayed and edited by a Microsoft Windows graphics interface.

In one embodiment, the method includes the step of retrieving a user selection for visual characteristics of annotation markings for the annotated text.

Various embodiments of the present invention further include, for example, any of, typographically marking fragments of text according to a representational status of the fragments, and/or contextually associating modeling help information with fragments of text as marked. The various embodiments may also include, for example, displaying modeling help information, and associating the help information with fragments of text, wherein the associations between the help information and the fragments of text are contextual and manifest in the displayed help information and text fragments.

Various embodiments of the invention may also include displaying the project hierarchy, wherein graphical signatures of package artifacts of the project hierarchy are presented in a photo album format. The photo album format may also be utilized, for example, for graphical signatures for any of activity diagram artifacts, case diagram artifacts, object relationship diagram artifacts, object network map artifacts, and/or other artifacts of packages of the project hierarchy.

In another embodiment, the present invention is a method, comprising the step of, associating modeling error traits with graphical representations of an object model; and may further comprise the step of displaying the modeling error traits. In one alternative, the associated traits are manifest in an activity diagram presentation.

Various embodiments of the present invention include the step of creating a hyperlink, and or activating a hyperlink, and/or displaying an activated hyperlink, between any pair of packages in the project hierarchy. The hyperlinks are, for example, between any of any package in the project hierarchy and any artifact stored in the project hierarchy, any package in the project hierarchy and any element of an artifact stored in the project hierarchy, any artifact in a package stored in the project hierarchy and any element of an artifact in a package stored in the project hierarchy, any element of an artifact in a package stored in the project hierarchy any other element of any artifact in a package stored in the project hierarchy, any pair of packages in the project hierarchy, any package in the project hierarchy and any artifact in a package of the project hierarchy, any package in the project hierarchy and any element of any artifact in a package in the project hierarchy.

In various embodiments, the present invention includes the step of accessing, and/or displaying, and/or modifying characteristics of an element of an object model from graphical representations of the present invention. The graphical representations include, for example, any of an activity diagram, a use case diagram, an object relationship diagram, an object network map diagram, an activity schedule, an action paradigm diagram, an actor/object list, or other representations.

In various embodiments, the step of accessing characteristics of any element of the object model may be performed from textual representations created from the object model. The textual representations comprise, for example, annotated text, and the accessed characteristics are, for example, displayed, modified.

In various embodiments, the invention includes, for example, a step of accessing, and/or displaying, and/or modifying relationships between any elements of the object model from certain of the graphical representations. The graphical relationships include, for example, any of, an object relationship diagram, object network map, or other representations.

In various embodiments, the present invention includes the step of creating a remodeling cache, in which a syntactic representation of a natural language text upon which the remodeling cache is based is stored in a rapidly accessible format. The remodeling cache is, for example, used to generate appropriate syntactic representations of previously modeled portions of the natural language text.

In describing preferred embodiments of the present invention illustrated in the drawings, specific terminology is employed for the sake of clarity. However, the present invention is not intended to be limited to the specific terminology so selected, and it is to be understood that each specific element includes all technical equivalents which operate in a similar manner. For example, when describing lexicons, hierarchies, topologies, or any other processes or features of the present invention, that any other equivalent device, or a device having an equivalent function or capability, whether or not listed herein, may be substituted therewith.

Furthermore, the inventors recognize that newly developed technologies not now known may also be substituted for the described parts and still not depart from the scope of the present invention. All described items, including, but not limited to type resolutions, syntactic representations, semantic processing or representations, diagram representations, views, linking management, etc. should also be considered in light of any and all available equivalents.

Portions of the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art based on the present disclosure.

The present invention includes a computer program product which is a storage medium (media) having instructions stored thereon/in which can be used to control, or cause, a computer to perform any of the processes of the present invention. The storage medium can include, but is not limited to, any type of disk including floppy disks, mini disks (MD's), optical discs, DVD, CD-ROMS, CDRW+/−, micro-drive, and magneto-optical disks, ROMs, RAMs, EPROMs, EEPROMs, DRAMs, VRAMs, flash memory devices (including flash cards, memory sticks), magnetic or optical cards, MEMS, nanosystems (including molecular memory ICs), RAID devices, remote data storage/archive/warehousing, or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing the present invention, as described above.

Included in the programming (software) of the general/specialized computer or microprocessor are software modules for implementing the teachings of the present invention, including, but not limited to, text entry and editing, parsing, creating object models (e.g., from natural language text), diagramming text based on object models, syntactic pattern recognition, creating textual representations of an object model, pairing tokens and lexical types, managing lexicons, linking representations in any of text, graphics, hierarchies, etc., inserting terms into lexicons, performing morphological inferences, type reduction processes, refinements, assignments, or any other processes described herein, and the display, storage, or communication of results according to the processes of the present invention.

The present invention may suitably comprise, consist of, or consist essentially of, any of the elements (the various parts or features of the invention) and their equivalents as described herein. Further, the present invention illustratively disclosed herein may be practiced in the absence of any element, whether or not specifically disclosed herein. Obviously, numerous modifications and variations of the present invention are possible in light of the above teachings. It is therefore to be understood that within the scope of the appended claims, the invention may be practiced otherwise than as specifically described herein.

### EXAMPLE 1

### Syntactic Type Resolution

originating text:

“The Scenario engine transforms informal natural language text
into formal object representations.”

parsed token sequence:

the Scenario engine transforms informal natural language
text into formal object representations .

```
initial lexical type sequence:
  ajd xim xom xax xjx xjq xom xom xyv xjx xox xom trm
  where the listed types are
```

```
ajd: definite article
xim: pni/mbj
xom: obj/mbj
xax: act/xom
xjx: adj/obj
xjq: xjv/obj
xyv: xyp/adv
xox: xom/act
trm: terminator
  with each virtual type (i.e. any type designated by an initial
  ‘x’ in its 3-letter code) defined by its refinement pair
  over the actual types
act: active verb
obj: object noun
adj: adjective
adv: adverb
mbj: object modifier
pni: inanimate proper name
```

and the further virtual types

xjv: adj/adv
xyp: xuq/xpq
xuq: imd/mim
xpq: prp/mpr

over the actual types

prp: preposition
imd: instrumental
mpr: meta-preposition
mim: meta-instrumental

```
initial reduction type sequence:
  ajd xom xom xax xjx xjq xom xom xyv xjx xox xom trm
initial reduction type pairings/rankings:
  11) (representations,.) / (xom,trm) // 20 / −1 <--
  10) (object,representations) / (xox,xom) // 0 / −1 <--
    9) (formal,object) / (xjx,xox) // 1 / −1
    8) (into,formal) / (xyv,xjx) // 0 / −1
    7) (text,into) / (xom,xyv) // 4 / −1
    6) (language,text) / (xom,xom) // 0 / −1
    5) (natural,language) / (xjq,xom) // 0 / −1
    4) (informal,natural) / (xjx,xjq) // 1 / −1
    3) (transforms,informal) / (xax,xjx) // 1 / −1
    2) (engine,transforms) / (xom,xax) // 0 / −1
    1) (Scenario,engine) / (xom,xom) // 0 / −1
    0) (the,Scenario) / (ajd,xom) // 1 / −1
presented in the format
  index) (token,token) / (type,type) // rank / order
where
  index is a reduction pair index for iteration reference
  token is a sentence token
  type is a reduction type
  rank is a type reduction priority ranking (0 = high, 21 = low)
  order is a type reduction dominance ordering (0 = first, 1 =
  second, −1 = neither)
[interwoven processes of type refinement and type reduction,
repeatedly executed here, produce the following intermediate
results:]
intermediate reduction type pairings/rankings:
  11) (representations,.) / (obj,trm) // 21 / 0 <--
  10) (object,representations) / (mbj,obj) // 1 / 1 <--
    9) (formal,object) / (adj,mbj) // 1 / 1
    8) (into,formal) / (xyv,adj) // 0 / −1 <--
    7) (text,into) / (xom,xyv) // 4 / −1
    6) (language,text) / (xom,xom) // 0 / −1
    5) (natural,language) / (xjq,xom) // 0 / −1
    4) (informal,natural) / (xjx,xjq) // 1 / −1
    3) (transforms,informal) / (xax,xjx) // 1 / −1
    2) (engine,transforms) / (xom,xax) // 0 / −1
    1) (Scenario,engine) / (xom,xom) // 0 / −1
    0) (the,Scenario) / (ajd,xom) // 1 / −1
type refinement sequence:
  xom xax xjx xjq xom xom [xyv] adj mbj obj trm nul nul
type refinement branch: xyv −> xyp/adv
estimated type sequence:
  xom xox xax ajd xjx xom [xyv] ajd mbj obj trm nul nul −> xyp
minimizing type refinement metric:
  8.66 8.79 8.70 8.32 7.62 6.53 [5.28] 3.86 2.52 1.47 0.69
  0.22 0.00 −> 40.07
type refinement sequence:
  xom xax xjx xjq xom xom [xyp] adj mbj obj trm nul nul
type refinement branch: xyp −> xuq/xpq
estimated type sequence:
  xax aji xap xtj xom xjq [xyp] ajd mbj obj trm nul nul −> xuq
minimizing type refinement metric:
```

8.92 8.90 8.35 7.84 7.17 6.04 [4.81] 3.60 2.38 1.36 0.64
0.22 0.00 −> 38.01

```
type refinement sequence:
  xom xax xjx xjq xom xom [xuq] adj mbj obj trm nul nul
type refinement branch: xuq −> imd/mim
estimated type sequence:
  xom xax xux xpg xjx xom [xuq] adj mbj obj trm nul nul −> mim
minimizing type refinement metric:
  8.32 8.42 8.16 7.54 6.67 5.40 [3.95] 2.55 1.50 0.69 0.16
  0.00 0.00 −> 34.60
intermediate reduction type pairings/rankings:
  11) (representations,.) / (obj,trm) // 21 / 0 <--
  10) (object,representations) / (mbj,obj) // 1 / 1 <--
    9) (formal,object) / (adj,mbj) // 1 / 1
    8) (into,formal) / (mim,adj) // 5 / 0
  10) (representations,.) / (obj,trm) // 21 / 0 <--
    9) (formal,representations) / (adj,obj) // 1 / 1 <--
    8) (into,formal) / (mim,adj) // 5 / 0
```

What is claimed and desired to be secured by letters patent of the united states is:

1. A diagramming method, comprising the steps of:
retrieving a text description of a process;
creating an object model of the text;
diagramming the text based on the object model; and
displaying the diagrammed text.

2. The method according to claim 1, wherein said step of creating an object model comprises:
creating the object model from natural language text via an adaptive, syntactic pattern recognition scheme.

3. A method for creating an open language structure from natural language text, where the open language structure is an adaptive, syntactic pattern recognition scheme based on a lexical type sequence topology.

4. A method, comprising the step of:
creating a basic lexicon;
wherein the basic lexicon is a lexicographically ordered list of lexical terms, where a lexical term is a pair consisting of an admissible token and an associated lexical type, a token is a string of ASCII characters, an admissible token is a token which is either a word or a punctuation symbol in a natural language, and a lexical type is a syntactic designation which specifies the possible grammatical roles its associated token can assume in a sentential context relative to that natural language.

5. The method according to claim 4, further comprising the step of managing the basic lexicon by viewing a lexical term in the basic lexicon.

6. The method according to claim 4, further comprising the step of managing the basic lexicon, whereby a lexical term may be inserted into a basic lexicon.

7. The method according to claim 4, further comprising the step of managing the basic lexicon, whereby a lexical term may be edited in a basic lexicon.

8. The method according to claim 4, further comprising the step of managing the basic lexicon, whereby a lexical term may be deleted from a basic lexicon.

9. The method according to claim 4, further comprising the step of:
assigning a lexical type, which forms one of the lexical terms, using a submethod of direct lexical reference to the basic lexicon.

10. The method according to claim 4, further comprising the step of:
assigning a lexical type, which forms one of the lexical terms, using a submethod of indirect morphological inference on token suffix formation.

11. The method according to claim 4, further comprising the step of:
assigning a lexical type, which forms one of the lexical terms, using a submethod of manual selection from a list of lexical types.

12. The method according to claim 4, further comprising the step of:
assigning a lexical type, which forms one of the lexical terms, by applying an appropriate lexical type assignment method.

13. The method according to claim 12, wherein:
the step of applying comprises at least one of,
using a submethod of direct lexical reference to the basic lexicon,
using a submethod of indirect morphological inference on token suffix formation, and
using a submethod of manual selection from a list of lexical types.

14. The method according to claim 13, wherein the applying submethod is determined by a character string signature of a given token.

15. A method for lexical type resolution, comprising the step of:
transforming a virtual type occurring in a lexical type sequence into an actual type, where a virtual lexical type is an ambiguous designation of grammatical role allowing for a number of possible outcomes in sentential context, and an actual lexical type is a fixed designation of grammatical role.

16. A method, comprising the step of:
creating a type reduction rank matrix, which is a reduction priority structure operating on the space of pairs of actual lexical types.

17. A method, comprising the step of:
creating a type reduction order matrix, which is a reduction dominance structure operating on the space of pairs of actual lexical types.

18. A method, comprising the step of:
defining a metric on a type sequence space by discrete convolution over at least one of,
a type reduction rank matrix, which is a reduction priority structure operating on the space of pairs of actual lexical types, and
a type reduction order matrix, which is a reduction dominance structure operating on the space of pairs of actual lexical types;
wherein a type sequence space is a set of lexical type sequences.

19. The method according to claim 18, further comprising the step of:
creating a type sequence topology of a space of lexical type sequences on which the metric has been defined.

20. The method according to claim 19, further comprising the step of:
correlating any element of the type sequence topology with an associated lexical type;
wherein the associated lexical type is the relative resolution value of the correlated element.

21. The method according to claim 19, further comprising the step of:
performing syntactic refinement, by,
assigning a relatively resolved lexical type to an unresolved lexical type in a type sequence, and
using a type correlation specifically determined by an optimization over the created type sequence topology.

22. A method for syntactic type reduction, comprising the steps of:
selecting an adjacent pair of fully resolved types according to the type reduction rank matrix; and
transforming the adjacent pair of fully resolved types in a type sequence into a remaining dominant type and a suppressed subordinate type;
wherein the transformation is based on a type reduction rank matrix comprising a reduction priority structure operating on the space of pairs of actual lexical types.

23. The method according to claim 15, further comprising the step of,
performing lexical type sequence resolution by iterated lexical type resolution, incorporating submethods comprising:
performing syntactic refinement, by,
assigning a relatively resolved lexical type to an unresolved lexical type in a type sequence, and
using a type correlation specifically determined by an optimization over the created type sequence topology; performing syntactic type reduction, comprising the steps of,
selecting an adjacent pair of fully resolved types according to a type reduction rank matrix, and
transforming the adjacent pair of fully resolved types in a type sequence into a remaining dominant type and a suppressed subordinate type,
wherein the transformation is based on the type reduction rank matrix comprising a reduction priority structure operating on a space of pairs of actual lexical types;
wherein lexical type sequence resolution by iterated lexical type resolution in an interwoven application which transforms any sequence of lexical types into a correlated sequence of actual types.

24. The method according to claim 23, further comprising the step of:
preparing a syntactic complex representation, which represents an actual lexical type sequence, where the syntactic complex is a syntactic dependency structure represented as a parse tree that encodes syntactic information required to perform further semantic processing.

25. The method according to claim 2, further comprising the step of accessing characteristics of any element of the object model from textual representations created from the object model.

26. The method according to claim 25, wherein the textual representations comprise annotated text.

27. The method according to claim 25, further comprising the step of displaying the accessed characteristics.

28. The method according to claim 26, further comprising the step of displaying the accessed characteristics.

29. The method according to claim 25, further comprising the step of modifying the accessed characteristics.

30. The method according to claim 28, further comprising the step of modifying the accessed characteristics.

31. A method, comprising the step of creating a remodeling cache, in which a syntactic representation of a natural language text upon which the remodeling cache is based is stored in a rapidly accessible format.

32. The method according to claim 31, wherein the remodeling cache is used to generate appropriate syntactic representations of previously modeled portions of the natural language text.
